(19) United States
(12) Patent Application Publication
(10) Pub. No.: US 2022/0345227 A1
(43) Pub. Date: Oct. 27, 2022

(54) SMART SENSOR FOR ZERO-TOUCH TRUSTED ASSOCIATION

(71) Applicant: Dell Products L.P., Round Rock, TX (US)

(72) Inventors: Shekar Babu SURYANARAYANA, Bangalore (IN); Manuel NOVOA, Leander, TX (US)

(73) Assignee: Dell Products L.P., Round Rock, TX (US)

(21) Appl. No.: 17/241,942

(22) Filed: Apr. 27, 2021

(51) Int. Cl. H04B 11/00; H04L 29/06; H04W 12/65; H04W 12/50

(52) U.S. Cl. CPC H04B 11/00; H04L 63/18; H04W 12/65; H04W 12/50

(57) ABSTRACT

An information handling system may include at least one processor; a wireless interface; and an ultrasonic retroreflector. In response to receiving an ultrasonic signal from a device external to the information handling system, the ultrasonic retroreflector may be configured to: transmit a reflected ultrasonic signal to the device; and cause the wireless interface to establish a wireless communications connection with the device.

### TECHNICAL FIELD

The present disclosure relates in general to information handling systems, and more particularly to the use of smart sensors for associating peripherals with information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems may be configured to wirelessly associate or “pair” with various types of trusted resources so that information can then be exchanged. Such resources may include docking stations, monitors, other peripherals, other information handling systems, etc. As one example, when a notebook computer approaches a wireless docking station, it may be desirable to automatically associate with the docking station and unlock the notebook. (For purposes of concreteness, this disclosure will discuss in detail the scenario of a notebook computer and a wireless docking station. One of ordinary skill in the art with the benefit of this disclosure will understand its applicability to other types of information handling systems and other types of resources.)

The ability to create associations automatically includes a “Zero Touch Wake” feature, and it currently requires keeping a wireless radio (e.g., WiFi, Bluetooth, etc.) active in order to continually search for resources. This can consume a significant amount of power, particularly in battery-powered information handling systems. For example, when a system is in standby, the wireless search operation may drain its battery unacceptably quickly.

Power mode features like “Modern Standby” may inhibit the Zero Touch Wake feature from functioning correctly when a notebook approaches its wireless docking station by turning off wireless radios. When a notebook is in Modern Standby mode, turning on the WiFi radio with search active consumes significant battery power.

For an open laptop, it may be possible to detect human presence and operate the authorized lock and unlock of the notebook. However, a different solution is needed to address the problem of a wireless dock triggering a “Zero Touch Authorized Wake” event for a notebook as it approaches the dock and associates with it. When a notebook is fully powered off, there is currently no “Zero Touch Authorized Power On” when it approaches an authorized wireless dock.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with pairing peripherals with information handling systems may be reduced or eliminated.

In accordance with embodiments of the present disclosure, an information handling system may include at least one processor; a wireless interface; and an ultrasonic retroreflector. In response to receiving an ultrasonic signal from a device external to the information handling system, the ultrasonic retroreflector may be configured to: transmit a reflected ultrasonic signal to the device; and cause the wireless interface to establish a wireless communications connection with the device. In accordance with these and other embodiments of the present disclosure, a method may include an information handling system receiving, at an ultrasonic retroreflector thereof, an ultrasonic signal from a device external to the information handling system; the information handling system transmitting, from the ultrasonic retroreflector, a reflected ultrasonic signal to the device; and the information handling system causing a wireless interface thereof to establish a wireless communications connection with the device.

In accordance with these and other embodiments of the present disclosure, an article of manufacture may include a non-transitory, computer-readable medium having computer-executable code thereon that is executable by a processor of an information handling system for: receiving, at an ultrasonic retroreflector of the information handling system, an ultrasonic signal from a device external to the information handling system; transmitting, from the ultrasonic retroreflector, a reflected ultrasonic signal to the device; and causing a wireless interface of the information handling system to establish a wireless communications connection with the device.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates an architectural flow diagram for associating an information handling system with a dock, in accordance with embodiments of the present disclosure; and

FIG. 3 illustrates a flow chart of wireless beacon exchange, in accordance with embodiments of the present disclosure.

### DETAILED DESCRIPTION

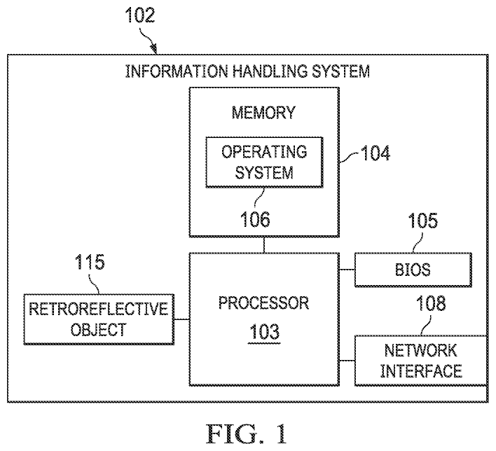

Preferred embodiments and their advantages are best understood by reference to FIGS. 1 through 3, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

As discussed in further detail below, information handling system 10 may further include a retroreflective object 115 that is operable to receive and reflect ultrasonic signals.

As discussed above, there are difficulties in automatically associating information handling system 102 with a trusted peripheral such as a wireless dock. In particular, if information handling system 102 is in a power saving state, its wireless radios may be turned off, which may prevent such association. The alternative of keeping the radios on or turning them on continually may waste a significant amount of power.

Accordingly, some embodiments of this disclosure may implement a sensor to enable zero-touch smart connectivity while consuming far less power than keeping the wireless radio of information handling system 102 powered on at all times. In one embodiment, one or more high-performance ultrasonic proximity sensors may be included in a wireless dock. Ultrasonic proximity sensors may emit and receive sound waves. The carrier signal may be a high-frequency, inaudible sound wave. Some ultrasonic sensors may have the transmitter and receiver packaged together in a single housing, while others may have the transmitter and receiver packaged separately.

In other embodiments, different types of proximity sensors may also be used in addition to or in lieu of ultrasonic proximity sensors.

The ultrasonic proximity sensors may be configured to send ultrasonic signals and detect reflections of such signals. Retroreflective object 115 in information handling system 102 may receive the signals from the dock's ultrasonic proximity sensor and return a reflection of the signals. In this way, information handling system 102 may be detected when it approaches the wireless dock (e.g., to within 10-12 meters or any suitable distance).

When the wireless dock detects a reflection from retroreflective object 115, the wireless dock may trigger a wireless radio of the wireless dock to begin polling for information handling system 102.

Further, retroreflective object 115 may itself be an active device that (even in power saving modes or in a powered-off state) draws a very small amount of current and is configured to trigger an event in information handling system 102 when the ultrasonic signal is received. This event may trigger a wireless radio of information handling system 102 to activate. Once the wireless radios are activated, information handling system 102 and the wireless dock may exchange Bluetooth/BLE beacons, and the trusted association process may begin.

In some embodiments, retroreflective object 115 may include a filter (e.g., a software-configurable filter) that may adjust the ultrasonic signal that is returned. Accordingly, characteristics of the ultrasonic signal may be used to identify the type of platform that is detected.

Further, this process may also trigger information handling system 102 to wake from its low-power mode and/or turn on from its powered-off state.

Accordingly, even in states in which its radios are disabled to save power, information handling system 102 may automatically pair with a wireless dock when a user brings the two devices in proximity to one another. The dock may then activate external monitors and other peripherals and communicatively couple them to information handling system without requiring user intervention.

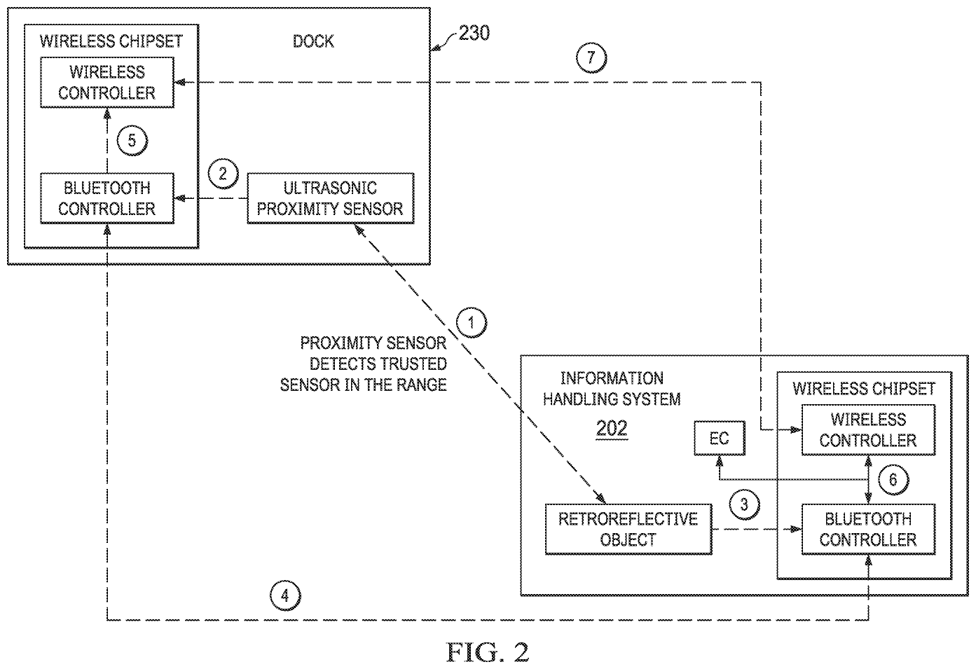

Turning now to FIG. 2, an architectural flow diagram is shown for associating information handling system 202 with dock 230. At step 1, an ultrasonic proximity sensor of dock 230 detects the approach of information handling system 202 to within a range of 10 meters. This may involve the ultrasonic proximity sensor sending out a pulse of ultrasonic energy and receiving a reflection of that pulse from the retroreflective object of information handling system 202.

At step 2, the ultrasonic proximity sensor of dock 230 wakes the Bluetooth Controller of dock 230 (e.g., with a GPIO event). At step 3, the retroreflective object of information handling system 202 wakes the Bluetooth controller of information handling system 202 (e.g., with a GPIO event).

At step 4, the Bluetooth controller of dock 230 initiates a signed beacon exchange with the Bluetooth controller of information handling system 202.

At step 5, if the beacon is trusted, the Bluetooth module of dock 230 wakes the wireless controller of dock 230. At step 6, the Bluetooth controller of information handling system 202 wakes the EC (embedded controller) to validate the beacon pattern. If the beacon is trusted, then the Bluetooth module of information handling system 202 wakes the wireless controller of information handling system 202.

Finally at step 7, the wireless controller of information handling system 202 discovers the wireless controller of dock 230 and associates with dock 230 wirelessly (e.g., over WiFi).

Although FIG. 2 discloses a particular number of steps to be taken with respect to the disclosed method, the method may be executed with greater or fewer steps than those depicted. In addition, although FIG. 2 discloses a certain order of steps to be taken with respect to the method, the steps may be completed in any suitable order. The method of FIG. 2 may be implemented using information handling system 102, information handling system 202, and/or any other system operable to implement the method. In certain embodiments, the method may be implemented partially or fully in software and/or firmware embodied in computer-readable media.

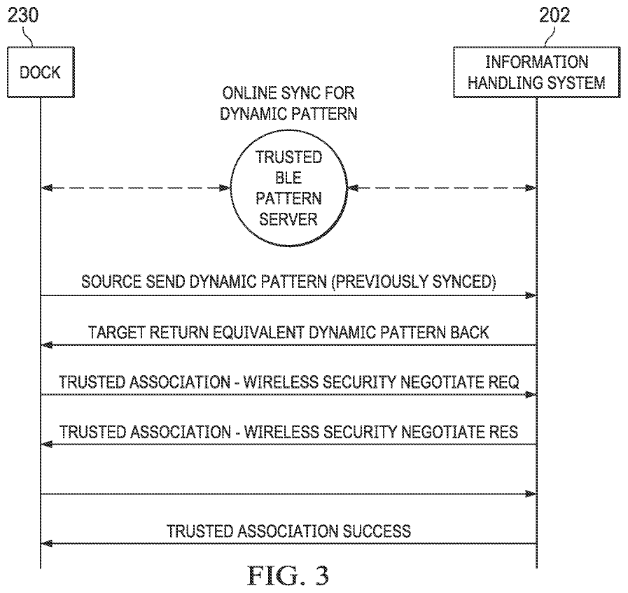

Turning now to FIG. 3, an example method for Bluetooth beacon pattern exchange is illustrated. It should be noted that in some embodiments, no authentication or encryption may be needed. In other embodiments, any standard procedure for authentication and/or encryption may be used. In yet other embodiments, the procedure illustrated in FIG. 3 may be used.

In some embodiments, a trusted BLE pattern server may be used to facilitate the pattern exchange by allowing devices to download the dynamic patterns/signatures that will be used. In some embodiments, the first time a device associates, it may use a factory-configured pattern. After the first time, dynamic patterns may be used.

In general, dock 230 may send a dynamic pattern, and information handling system 202 may return an equivalent dynamic pattern. Then dock 230 may send a trusted association wireless security negotiation request, and information handling system 202 may return a trusted association wireless security negotiation response. After the negotiation, the trusted association connection is established.

In some embodiments, a “theme” may be established, which is an agreement between the devices for what the next set of pairing codes will be for subsequent associations. Any suitable method for agreeing on a cryptographic code may be used to establish the theme.

At information handling system 202, the source and destination pattern/signature may be joined together to form the pre-selected theme by the user, which results in establishing a trusted session. If the pre-selected theme is not formed, then the session may be closed. If the pattern/signature is not valid, then the Bluetooth controller may be turned off. In some embodiments, a user may be able to configure patterns (e.g., random patterns) at the trusted BLE pattern server, so that the server can break a single pattern into two pieces. The server may then sync the first piece by encoding it for one device and the second piece by encoding it for the other device. Then the devices may decode and join the pieces to result in the original complete pattern.

Although FIG. 3 discloses a particular number of steps to be taken with respect to the disclosed method, the method may be executed with greater or fewer steps than those depicted. In addition, although FIG. 3 discloses a certain order of steps to be taken with respect to the method, the steps may be completed in any suitable order. The method of FIG. 3 may be implemented using information handling system 102, information handling system 202, and/or any other system operable to implement the method. In certain embodiments, the method may be implemented partially or fully in software and/or firmware embodied in computer-readable media.

Although various possible advantages with respect to embodiments of this disclosure have been described, one of ordinary skill in the art with the benefit of this disclosure will understand that in any particular embodiment, not all of such advantages may be applicable. In any particular embodiment, some, all, or even none of the listed advantages may apply.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Unless otherwise specifically noted, articles depicted in the drawings are not necessarily drawn to scale. However, in some embodiments, articles depicted in the drawings may be to scale.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor;
a wireless interface; and
an ultrasonic retroreflector;
wherein, in response to receiving an ultrasonic signal from a device external to the information handling system, the ultrasonic retroreflector is configured to:
transmit a reflected ultrasonic signal to the device; and
cause the wireless interface to establish a wireless communications connection with the device.

2. The information handling system of claim 1, wherein the wireless interface is a Bluetooth interface.

3. The information handling system of claim 1, wherein the device is a wireless docking station.

4. The information handling system of claim 1, wherein the information handling system is a notebook computer system.

5. The information handling system of claim 1, wherein the information handling system is further configured to exit a power-saving state in response to the ultrasonic signal.

6. The information handling system of claim 1, wherein the information handling system is further configured to power on from a powered-off state in response to the ultrasonic signal.

7. A method comprising:
an information handling system receiving, at an ultrasonic retroreflector thereof, an ultrasonic signal from a device external to the information handling system;
the information handling system transmitting, from the ultrasonic retroreflector, a reflected ultrasonic signal to the device; and
the information handling system causing a wireless interface thereof to establish a wireless communications connection with the device.

8. The method of claim 7, wherein the wireless interface is a Bluetooth interface.

9. The method of claim 7, wherein the device is a wireless docking station.

10. The method of claim 7, wherein the information handling system is a notebook computer system.

11. The method of claim 7, further comprising: the information handling system exiting a power-saving state in response to the ultrasonic signal.

12. The method of claim 7, further comprising: the information handling system powering on from a powered-off state in response to the ultrasonic signal.

13. An article of manufacture comprising a non-transitory, computer-readable medium having computer-executable code thereon that is executable by a processor of an information handling system for:
receiving, at an ultrasonic retroreflector of the information handling system, an ultrasonic signal from a device external to the information handling system;
transmitting, from the ultrasonic retroreflector, a reflected ultrasonic signal to the device; and
causing a wireless interface of the information handling system to establish a wireless communications connection with the device.

14. The article of claim 13, wherein the wireless interface is a Bluetooth interface.

15. The article of claim 13, wherein the device is a wireless docking station.

16. The article of claim 13, wherein the information handling system is a notebook computer system.

17. The article of claim 13, wherein the information handling system is further configured to exit a power-saving state in response to the ultrasonic signal.

18. The article of claim 13, wherein the information handling system is further configured to power on from a powered-off state in response to the ultrasonic signal.
